(19) United States
(12) Patent Application Publication
(10) Pub. No.: US 2024/0263373 A1
(43) Pub. Date: Aug. 8, 2024

(54) COMPOSITE OF HIGH-STRENGTH FIBERGLASS MESH AND POLYPROPYLENE NON-WOVEN FABRIC AND PREPARATION METHOD THEREFOR

(71) Applicant: GUANGZHOU ENVIRONSTAR ENTERPRISE LTD., Guangzhou (CN)

(72) Inventor: Peiheng FENG, Guangzhou (CN)

(73) Assignee: GUANGZHOU ENVIRONSTAR ENTERPRISE LTD., Guangzhou (CN)

(21) Appl. No.: 18/131,878

(22) Filed: Apr. 7, 2023

Related U.S. Application Data
(63) Continuation of application No. PCT/CN2023/077883, filed on Feb. 23, 2023.

(30) Foreign Application Priority Data
Feb. 3, 2023 (CN) 202310080605.5

(51) Int. Cl. D04H 3/007; D04H 1/4218; D04H 1/4291; D04H 1/435; D04H 3/12; D04H 3/147

(52) U.S. Cl. CPC D04H 3/007; D04H 1/4218; D04H 1/4291; D04H 1/435; D04H 3/12; D04H 3/147

(57) ABSTRACT

Disclosed is a polypropylene non-woven fabric made of a composite of high-strength fiberglass mesh and polypropylene non-woven fabric where the polypropylene non-woven fabric is ≥2 layers, and between each two layers of polypropylene non-woven fabric is a layer of high-strength fiberglass mesh. The high-strength fiberglass mesh is interwoven with monofilaments including one or more of polyethylene, polypropylene and polyethylene terephthalate. A method for preparing the composite of high-strength fiberglass mesh and polypropylene non-woven fabric is also disclosed. The composite of high-strength fiberglass mesh and polypropylene non-woven fabric is lighter than similar products of conventional spunbonded non-woven fabrics with a weight of 40 gsm to 110 gsm that is 40% to 80% of the weight of similar products, with a breaking strength 2 times or more of the same products and consistent in the longitudinal direction and the transverse direction.

### CROSS REFERENCE TO THE RELATED APPLICATIONS

This application is a continuation of PCT Application No. PCT/CN2023/077883, filed Feb. 23, 2023, which is based upon and claims priority to Chinese Patent Application No. 202310080605.5, filed Feb. 3, 2023.

### TECHNICAL FIELD

The present invention relates to the technical field of polypropylene non-woven fabrics, and in particular to a composite of high-strength fiberglass mesh and polypropylene non-woven fabric and a preparation method thereof.

### BACKGROUND

Polypropylene non-woven fabric, also known as non-woven cloth, is composed of oriented or random fibers. It is a new generation of environmentally friendly material that is highly strong, moisture-proof, breathable, flexible, lightweight, non-combustible, easy-to-decompose, non-toxic and non-irritating, low-costing, recyclable, etc. Most of the polypropylene non-woven fabrics are made of polypropylene (PP material) pellets as raw materials, which are produced in one step by melting at high temperature, spinning, drafting, cooling, lapping, hot rolling and bonding, and winding up. Polypropylene non-woven fabric is a fabric formed without spinning and weaving. It is formed by orienting or randomly arranging textile short fibers or filaments into a fiber web, and then reinforced using a mechanical, hot bonding or chemical method. Polypropylene non-woven fabric is a breakthrough in the traditional textile principle and features short technical process, high production rate, high yield, low cost, wide application and wide source of raw materials, etc.

Polypropylene non-woven fabric products are rich in color, bright, fashionable, environmentally friendly, widely applicable, elegant and pleasing to the eye, with a variety of patterns and styles, and are lightweight, environmentally friendly and recyclable as well, which are internationally recognized as environmentally friendly products for protecting the earth's ecology. Polypropylene non-woven fabric products can be used for industries such as agricultural films, shoemaking, leather making, mattresses, decoration, chemical engineering, printing, automobiles, building materials, furniture, and can also be used for clothing interlinings, medical and sanitary disposable operating gowns, masks, hats, bed sheets, hotel disposable tablecloths, cosmetology, sauna and even fashionable gift bags, boutique shopping bags, advertisement bags and the like.

However, the current polypropylene non-woven fabric products have the defects of insufficient and uneven strength, and in most cases, the weight is increased while the strength is enhanced, so that the requirements for light weight and high-strength and high-performance products could not be met. Therefore, it is of great significance to study and obtain a polypropylene non-woven fabric composite product that is light in weight, high and even in strength.

### SUMMARY

The present invention aims to overcome the defects in the prior art and provides a composite of high-strength fiberglass mesh and polypropylene non-woven fabric and a preparation method therefor, so as to solve the problem of insufficient strength of polypropylene non-woven fabric.

In order to achieve the above objective, the present invention provides the following technical solutions:

The present invention provides a composite of high-strength fiberglass mesh and polypropylene non-woven fabric, wherein in the composite of high-strength fiberglass mesh and polypropylene non-woven fabric, a number of layers of the polypropylene non-woven fabric is ≥2, and between each two layers of the polypropylene non-woven fabric is a layer of high-strength fiberglass mesh;
the high-strength fiberglass mesh is interwoven with monofilaments comprising one or more of polyethylene, polypropylene and polyethylene terephthalate.

Preferably, fineness of the monofilaments is 5 D to 200 D.

Preferably, a transverse distance and a longitudinal distance of the monofilaments in the high-strength fiberglass mesh are 0.5 mm to 30 mm independently.

The present invention further provides a method for preparing the composite of high-strength fiberglass mesh and polypropylene non-woven fabric, wherein the polypropylene non-woven fabric and the high-strength fiberglass mesh are bonded to obtain a composite of high-strength fiberglass mesh and polypropylene non-woven fabric;
a way of the bonding is hot-melting bonding, adhesive bonding or ultrasonic bonding.

Preferably, a temperature for the bonding is 80° C. to 220° C.

Preferably, a rate of the bonding is 20 m/min to 220 m/min.

Preferably, the adhesive bonding is conducted by glue spraying, glue spreading, glue scraping or glue impregnating, and an amount of an adhesive is 5 gsm to 25 gsm.

Preferably, the adhesive is a hot-melt pressure-sensitive adhesive, an EVA hot-melt adhesive or a PUR adhesive.

Preferably, a frequency of ultrasonic waves is 15 KHz to 30 KHz.

The present invention has the following beneficial effects:
In the composite of high-strength fiberglass mesh and polypropylene non-woven fabric of the present invention, a high-strength monofilament woven mesh is sandwiched between two layers of polypropylene non-woven fabrics, and thereby the effective strength of the product can be ensured by adjusting the longitudinal or transverse spacing of the monofilaments and the thickness of the monofilaments. The composite of high-strength fiberglass mesh and polypropylene non-woven fabric of the present invention is lighter than similar products (the similar products are conventional spunbonded non-woven fabrics with a weight of 40 gsm to 110 gsm), and is 40% to 80% of the weight of the similar products. Its breaking strength can reach 2 times or more of the same products with the same weight, and is consistent in the longitudinal direction and the transverse direction, thereby meeting the needs of different products.

### BRIEF DESCRIPTION OF THE DRAWINGS

FIG. 1 is a schematic structural diagram of the composite of high-strength fiberglass mesh and polypropylene non-woven fabric according to Example 1, wherein, 1-1 is the polypropylene non-woven fabric layer, 2-2 is the high-strength fiberglass mesh layer, and 3-3 is the polypropylene non-woven fabric layer;

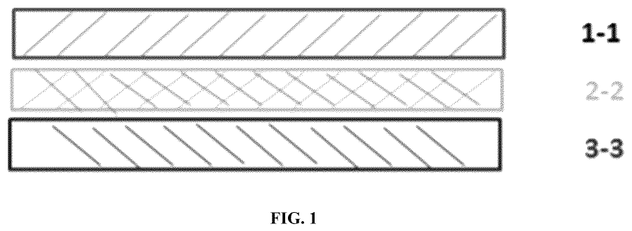

FIG. 2 is a schematic diagram of the method for preparing the composite of high-strength fiberglass mesh and polypropylene non-woven fabric according to Example 1, wherein, 1-1 is the polypropylene non-woven fabric, 2-2 is the high-strength fiberglass mesh, 3-3 is the polypropylene non-woven fabric, 4-4 is a press roller, 5-5 is a winding shaft, and 6-6 is an EVA hot-melt adhesive;

FIG. 3 is a schematic diagram of the method for preparing the composite of high-strength fiberglass mesh and polypropylene non-woven fabric according to Example 2, wherein, 1-1 is the polypropylene non-woven fabric, 2-2 is the high-strength fiberglass mesh, 3-3 is the polypropylene non-woven fabric, 4-4 is a hot-rolling press roller, and 5-5 is a winding shaft.

### DETAILED DESCRIPTION OF THE INVENTION

The present invention provides a composite of high-strength fiberglass mesh and polypropylene non-woven fabric, wherein in the composite of high-strength fiberglass mesh and polypropylene non-woven fabric, a number of layers of the polypropylene non-woven fabric is ≥2, and between each two layers of the polypropylene non-woven fabric is a layer of high-strength fiberglass mesh;
the high-strength fiberglass mesh is interwoven with monofilaments comprising one or more of polyethylene, polypropylene and polyethylene terephthalate.

In the present invention, the thickness of each layer of polypropylene non-woven fabric is preferably 0.01 mm to 10 mm, further preferably 0.1 mm to 5 mm, and more preferably 0.5 mm to 1 mm; and the thickness of each layer of high-strength fiberglass mesh is preferably 0.02 mm to 15 mm, further preferably 0.1 mm to 10 mm, and more preferably 1 mm to 5 mm.

In the composite of high-strength fiberglass mesh and polypropylene non-woven fabric of the present invention, the number of layers of the polypropylene non-woven fabric is preferably 2 to 5, and further preferably 2 to 4.

In the present invention, the polypropylene non-woven fabric is made of polypropylene as the raw material and by a conventional spunbonding method known to those skilled in the art.

In the present invention, the high-strength fiberglass mesh is interwoven longitudinally and transversely with monofilaments, and the monofilaments preferably comprise polyethylene and polyethylene terephthalate or polypropylene and polyethylene terephthalate, and further preferably comprise polyethylene, polypropylene and polyethylene terephthalate.

In the present invention, the fineness of the monofilaments is preferably 5 D to 200 D, further preferably 20 D to 150 D, and more preferably 30 D to 100 D.

In the high-strength fiberglass mesh of the present invention, the independent transverse distance and longitudinal distance of the monofilaments are preferably 3 mm to 20 mm, further preferably 5 mm to 15 mm, and more preferably 8 mm to 10 mm.

The present invention further provides a method for preparing the composite of high-strength fiberglass mesh and polypropylene non-woven fabric, wherein the polypropylene non-woven fabric and the high-strength fiberglass mesh are bonded to obtain a composite of high-strength fiberglass mesh and polypropylene non-woven fabric;
a way of the bonding is hot-melting bonding, adhesive bonding or ultrasonic bonding.

In the present invention, a temperature for the bonding is preferably 100° C. to 160° C., further preferably 110° C. to 150° C., and more preferably 120° C. to 140° C.

In the present invention, a rate of the bonding is preferably 40 m/min to 160 m/min, further preferably 50 m/min to 150 m/min, and more preferably 80 m/min to 120 m/min.

In the present invention, the adhesive bonding is preferably conducted by glue spraying, glue spreading, glue scraping or glue impregnating, and an amount of an adhesive is preferably 8 gsm to 25 gsm, further preferably 10 gsm to 20 gsm, and more preferably 12 gsm to 15 gsm.

In the present invention, the adhesive is preferably a hot-melt pressure-sensitive adhesive, an EVA hot-melt adhesive or a PUR adhesive, and the PUR adhesive is a moisture-curing reactive polyurethane hot-melt adhesive.

In the present invention, a frequency of ultrasonic waves is preferably 15 KHz to 30 KHz, further preferably 18 KHz to 25 KHz, and more preferably 20 KHz to 22 KHz.

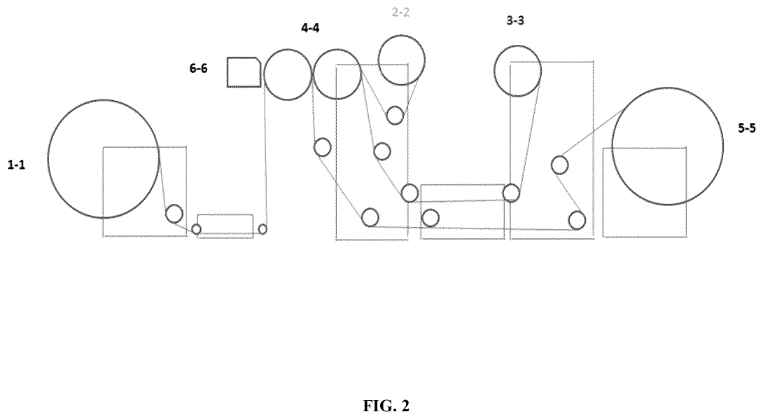

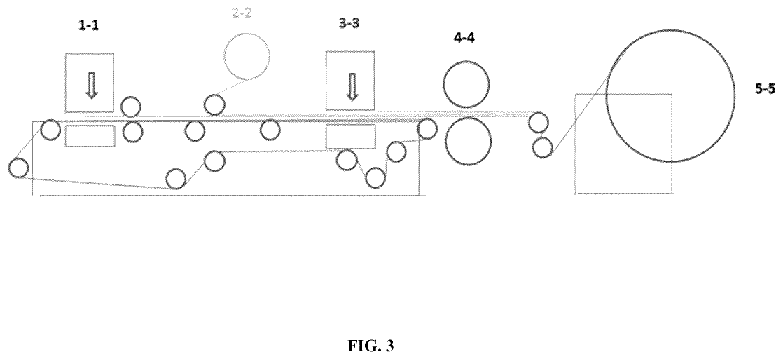

In the present invention, in the process of bonding the polypropylene non-woven fabric and the high-strength fiberglass mesh, the upper and lower layers of non-woven fabrics are tensioned separately with a drawing tension controller, and the high-strength fiberglass mesh is unwound with tension controlled by another drawing tension controller. The purpose of controlling the tension is to ensure that the polypropylene non-woven fabric and the high-strength fiberglass mesh are not wrinkled, thereby ensuring that there's no wrinkle on the product. The drawing tension is preferably 5 N to 50 N, further preferably 10 N to 40 N, and more preferably 15 N to 30 N; and the unwinding and winding in FIG. 2 and FIG. 3 both use a tension control device to control the tension.

The technical solutions provided by the present invention will be described in detail below with reference to the examples, which, however, should not be construed as limiting the protection scope of the present invention.

### Example 1

Three unwinding shafts (1-1 is polypropylene non-woven fabric, 2-2 is high-strength fiberglass mesh, and 3-3 is polypropylene non-woven fabric) and one winding shaft (5-5) are mounted on the equipment (as shown in FIG. 2). The high-strength fiberglass mesh is made of polyethylene and polyethylene terephthalate both with a fineness of 100 D, which are interwoven longitudinally and transversely, with a transverse distance of 5 mm and a longitudinal distance of 8 mm. The unwinding shaft (2-2) is an anilox roller on which mesh is placed. The (1-1, 2-2, 3-3, 5-5) shafts are well mounted and the drawing tension is preset to 15 N. The thickness of each layer of polypropylene non-woven fabric is 0.08 mm and that of high-strength fiberglass mesh is 0.08 mm.

The equipment (6-6) adopts a spraying process that sprays EVA hot-melt adhesive on polypropylene non-woven fabric and high-strength fiberglass mesh to bond the high-strength fiberglass mesh and polypropylene non-woven fabric, where the amount of EVA hot-melt adhesive is 15 gsm, the temperature for bonding is 120° C., and the rate is 100 m/min.

The press roller (4-4) bonds the high-strength fiberglass mesh and the polypropylene non-woven fabric more effectively. After bonding and going over the transition roller, a composite of high-strength fiberglass mesh and polypropylene non-woven fabric is wound up at the roller (5-5) and obtained.

The composite of high-strength fiberglass mesh and polypropylene non-woven fabric of the example is lighter than similar products (the similar products are conventional spunbonded non-woven fabrics with a weight of 70 gsm), and is 50% of the weight of the similar products. Its breaking strength can reach 2 times of the same products with the same weight, and is consistent in the longitudinal direction and the transverse direction.

### Example 2

A mesh former for non-woven fabric (1-1 is polypropylene non-woven fabric, 3-3 is polypropylene non-woven fabric), one unwinding shaft (2-2 is high-strength fiberglass mesh) and one winding shaft (5-5) are mounted on the equipment (as shown in FIG. 3). The high-strength fiberglass mesh is made of polyethylene, polypropylene and polyethylene terephthalate, all with a fineness of 30 D, which are interwoven longitudinally and transversely, with a transverse distance of 10 mm and a longitudinal distance of 10 mm. Winding up and overlapping all (1-1, 2-2, 3-3), with the thickness of each layer of polypropylene non-woven fabric of 0.08 mm and that of high-strength fiberglass mesh of 0.08 mm.

The hot-rolling press roller (4-4) is instantaneously heated by ultrasonic waves for bonding the high-strength fiberglass mesh and the polypropylene non-woven fabric, where the temperature for bonding is 150° C., the rate is 50 m/min, and the frequency of the ultrasonic waves is 20 KHz. After bonding and going over the transition roller, a composite of high-strength fiberglass mesh and polypropylene non-woven fabric is wound up at the roller (5-5) and obtained.

The composite of high-strength fiberglass mesh and polypropylene non-woven fabric of the example is lighter than similar products (the similar products are conventional spunbonded non-woven fabrics with a weight of 80 gsm), and is 45% of the weight of the similar products. Its breaking strength can reach 2.5 times of the same products with the same weight, and is consistent in the longitudinal direction and the transverse direction.

### Example 3

The high-strength fiberglass mesh is made of polypropylene and polyethylene terephthalate both with a fineness of 7 D, which are interwoven longitudinally and transversely, with a transverse distance of 5 mm and a longitudinal distance of 5 mm. The drawing tension is preset to 25 N, the temperature for bonding is 140° C., the rate is 150 m/min, and other conditions are the same as those of Example 1.

The composite of high-strength fiberglass mesh and polypropylene non-woven fabric of the example is lighter than similar products (the similar products are conventional spunbonded non-woven fabrics with a weight of 70 gsm), and is 48% of the weight of the similar products. Its breaking strength can reach 2.2 times of the same products with the same weight, and is consistent in the longitudinal direction and the transverse direction.

### Example 4

The high-strength fiberglass mesh is made of polyethylene, polypropylene and polyethylene terephthalate, all with a fineness of 20 D, which are interwoven longitudinally and transversely, with a transverse distance of 10 mm and a longitudinal distance of 15 mm. The hot-rolling press roller (4-4) bonds the high-strength fiberglass mesh and the polypropylene non-woven fabric with a hot-melting method using hot oil, with a temperature for bonding of 140° C. and a rate of 150 m/min, and other conditions the same as those in Example 2.

The composite of high-strength fiberglass mesh and polypropylene non-woven fabric of the example is lighter than similar products (the similar products are conventional spunbonded non-woven fabrics with a weight of 80 gsm), and is 43% of the weight of the similar products. Its breaking strength can reach 2.4 times of the same products with the same weight, and is consistent in the longitudinal direction and the transverse direction.

In the composite of high-strength fiberglass mesh and polypropylene non-woven fabric of the present invention, a high-strength monofilament woven mesh is sandwiched between two layers of polypropylene non-woven fabrics, and thereby the effective strength of the product can be ensured by adjusting the longitudinal or transverse spacing of the monofilaments and the thickness of the monofilaments. The composite of high-strength fiberglass mesh and polypropylene non-woven fabric of the present invention is lighter than similar products (the similar products are conventional spunbonded non-woven fabrics with a weight of 40 gsm to 110 gsm), and is 40% to 80% of the weight of the similar products. Its breaking strength can reach 2 times or more of the same products with the same weight, and is consistent in the longitudinal direction and the transverse direction, thereby meeting the needs of different products.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A composite of high-strength fiberglass mesh and polypropylene non-woven fabric, wherein, in the composite of high-strength fiberglass mesh and polypropylene non-woven fabric, a number of layers of the polypropylene non-woven fabric is ≥2, and between each two layers of the polypropylene non-woven fabric is a layer of high-strength fiberglass mesh; wherein the high-strength fiberglass mesh is interwoven with monofilaments comprising one or more of polyethylene, polypropylene and polyethylene terephthalate.

2. The composite of high-strength fiberglass mesh and polypropylene non-woven fabric according to claim 1, wherein, a fineness of the monofilaments is 5 D to 200 D.

3. The composite of high-strength fiberglass mesh and polypropylene non-woven fabric according to claim 1, wherein, in the high-strength fiberglass mesh, a transverse distance and a longitudinal distance of the monofilaments are 0.5 mm to 30 mm independently.

4. A method for preparing the composite of high-strength fiberglass mesh and polypropylene non-woven fabric according to claim 1, wherein, the polypropylene non-woven fabric and the high-strength fiberglass mesh are bonded to obtain the composite of high-strength fiberglass mesh and polypropylene non-woven fabric; and a way of the bonding is selected from hot-melting bonding, adhesive bonding or ultrasonic bonding.

5. The preparation method according to claim 4, wherein, a temperature for the way of bonding is 80° C. to 220° C.

6. The preparation method according to claim 4, wherein, a rate of the way of bonding is 20 m/min to 220 m/min.

7. The preparation method according to claim 6, wherein, the adhesive bonding is conducted by glue spraying, glue spreading, glue scraping or glue impregnating, and an amount of an adhesive is 5 gsm to 25 gsm.

8. The preparation method according to claim 7, wherein, the adhesive is a hot-melt pressure-sensitive adhesive, an EVA hot-melt adhesive or a PUR adhesive.

9. The preparation method according to claim 4, wherein, a frequency of ultrasonic waves is 15 KHz to 30 KHz.

10. The composite of high-strength fiberglass mesh and polypropylene non-woven fabric according to claim 2, wherein, in the high-strength fiberglass mesh, a transverse distance and a longitudinal distance of the monofilaments are 0.5 mm to 30 mm independently.

11. A method for preparing the composite of high-strength fiberglass mesh and polypropylene non-woven fabric according to claim 2, wherein, the polypropylene non-woven fabric and the high-strength fiberglass mesh are bonded to obtain the composite of high-strength fiberglass mesh and polypropylene non-woven fabric; and a way of the bonding is selected from hot-melting bonding, adhesive bonding or ultrasonic bonding.

12. A method for preparing the composite of high-strength fiberglass mesh and polypropylene non-woven fabric according to claim 3, wherein, the polypropylene non-woven fabric and the high-strength fiberglass mesh are bonded to obtain the composite of high-strength fiberglass mesh and polypropylene non-woven fabric; and a way of the bonding is selected from hot-melting bonding, adhesive bonding or ultrasonic bonding.

13. A method for preparing the composite of high-strength fiberglass mesh and polypropylene non-woven fabric according to claim 10, wherein, the polypropylene non-woven fabric and the high-strength fiberglass mesh are bonded to obtain the composite of high-strength fiberglass mesh and polypropylene non-woven fabric; and a way of the bonding is selected from hot-melting bonding, adhesive bonding or ultrasonic bonding.

14. The preparation method according to claim 5, wherein, a rate of the way of bonding is 20 m/min to 220 m/min.

15. The preparation method according to claim 13, wherein, the adhesive bonding is conducted by glue spraying, glue spreading, glue scraping or glue impregnating, and an amount of an adhesive is 5 gsm to 25 gsm.

16. The preparation method according to claim 14, wherein, the adhesive is a hot-melt pressure-sensitive adhesive, an EVA hot-melt adhesive or a PUR adhesive.

17. The preparation method according to claim 5, wherein, a frequency of ultrasonic waves is 15 KHz to 30 KHz.

18. The preparation method according to claim 11, wherein, a temperature for the way of bonding is 80° C. to 220° C.

19. The preparation method according to claim 12, wherein, a temperature for the way of bonding is 80° C. to 220° C.
